(19) United States
(12) Patent Application Publication
(10) Pub. No.: US 2024/0027841 A1
(43) Pub. Date: Jan. 25, 2024

(54) DISPLAY PANEL AND LIQUID CRYSTAL DISPLAY DEVICE

(71) Applicant: Ying Zhou, Shenzhen, Guangdong (CN)

(72) Inventor: Ying Zhou, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/615,082

(22) PCT Filed: Oct. 29, 2021
(86) PCT No.: PCT/CN2021/127589

§ 371 Date: Apr. 27, 2023

(30) Foreign Application Priority Data
Oct. 22, 2021 (CN) 202111231907.5

(51) Int. Cl. G02F 1/1339; G02F 1/1345

(52) U.S. Cl. CPC G02F 1/1339; G02F 1/13458

(57) ABSTRACT

The application discloses a display panel and a liquid crystal display device. A portion of the display panel corresponding to a peripheral area includes a sealant, a first metal layer, an organic film layer, a pad area, a first conductive layer, and a second conductive layer. An organic film layer includes a first flat portion, a second flat portion, and at least one via hole. The first conductive layer includes a conductive pad covering the first signal line in the via hole. The second conductive layer is arranged on one side of the second substrate adjacent to the sealant. Some of the conductive particles are located on the conductive pad of the second flat portion and contact the second conductive layer, and the first signal line is electrically connected to the second conductive layer via the conductive pad and the conductive particles.

### BACKGROUND OF INVENTION

### 1. Field of Invention

The present application relates to a technical field of displays, and more particularly to a display panel and a liquid crystal display device.

### 2. Related Art

With development of display technologies, display panels have been widely applied in various fields and used in a variety of electronic products, such as mobile phones, portable multimedia devices, notebook computers, televisions, and monitors, etc. Concerning market demands, more and more companies are committed to researching large-sized, high-resolution, and ultra-narrow bezel display products, or even bezel-less ones. Therefore, it is obvious that ultra-narrow bezel display products will become more and more trendy in the future.

For ultra-narrow bezel products, due to width limitations of the frame, a sealant containing conductive particles is generally used to conduct the upper and lower substrates. More specifically, the conductive particles are used for conducting the electrode layer of the color film substrate and the first metal layer or second metal layer of the array substrate, and this is the reason why each conduction location needs to be designed with via holes. The aforementioned sealant containing conductive particles suggests that the sealant and conductive particles are uniformly mixed with a certain ratio. Once the sealant is coated, the coated part is provided with the conductive particles. A possible issue is that when the conductive particles exist at both a bus line area and an opening of a conducting location (i.e., via holes), there is a gap between the two locations, causing the brightness of the peripheral areas to be non-uniform (mura) when displaying images.

### SUMMARY OF INVENTION

The present application is to provide a display panel and a liquid crystal display device, which is capable of solving the problem in the related art that conductive particles of sealants of display panels cannot effectively contact second conductive layers to conduct upper substrates and lower substrates, thereby reducing the difference height between bus line areas and conducting locations which can cause the brightness of peripheral areas to be non-uniform (i.e., the mura) when displaying images and adversely affect the display quality.

To solve the above problem, the present application provides technical solutions as follows:

An embodiment of the present application provides a display panel that includes a display area, a peripheral area adjacent to the display area, a first substrate, a second substrate arranged opposite to the first substrate, and a display layer, wherein in a portion corresponding to the peripheral area, the display panel includes a sealant, a first metal layer, an organic film layer, a pad area, a first conductive layer, and a second conductive layer. The sealant includes a plurality of conductive particles. The first metal layer is arranged above the first substrate and includes at least one first signal line. The organic film layer is arranged on the first metal layer and includes a first flat portion, a second flat portion, and at least one via hole defined between the first flat portion and the second flat portion, wherein the via hole exposes the first signal line, and a vertical level of a top surface of the second flat portion is higher than a vertical level of a top surface of the first flat portion is located. The pad area is defined on the first signal line, wherein the via hole is located in the pad area. The first conductive layer is arranged on the first substrate and including a conductive pad, wherein the conductive pad covers the first signal line in the via hole and is arranged extending to the top surfaces of the first flat portion and the second flat portion adjoining the via hole. The second conductive layer is arranged on one side of the second substrate adjacent to the sealant. Some of the conductive particles are located on the conductive pad of the second flat portion and contacting the second conductive layer, and the first signal line is electrically connected to the second conductive layer via the conductive pad and the conductive particles.

Optionally, the display panel may further comprise a gate insulating layer and a passivation layer sequentially provided between the first signal line and the second flat portion of the organic film layer, wherein the passivation layer is located between the first signal line and the first flat portion of the organic film layer, the gate insulating layer under the second flat portion is stacked on some of the first signal line, and the passivation layer under the first flat portion is stacked on some of the first signal line.

Optionally, a total thickness of entire film layers between an upper surface of the first substrate and the top surface of the second flat portion of the organic film layer is defined as a bus line area film thickness, and a total thickness of entire film layers above the upper surface of the first substrate in the display area is defined as a display area film thickness, wherein calculation of a size of the conductive particles is based at least on a premise that the bus line area film thickness and the display area film thickness are equal.

Optionally, the conductive pad extends out of the pad area in a first direction or in a second direction, and an orthographic projection area of the conductive pad on the first substrate is larger than an orthographic projection area of the pad area on the first substrate.

Optionally, the first metal layer further includes at least one second signal line, the second signal line is spaced apart from the first signal line, and the conductive pad extends in the second direction to the second signal line.

Optionally, the first direction is a direction along which the sealant is coated on the peripheral area, and the second direction is perpendicular to the first direction.

Optionally, an orthographic projection area of the second flat portion of the organic film layer on the first substrate is larger than an orthographic projection area of the first flat portion of the organic film layer on the first substrate.

Optionally, the organic film layer includes the plurality of via holes, the plurality of via holes are spaced apart from each other, and an orthographic projection area of the plurality of via holes on the first substrate is located in an orthographic projection area of the conductive pad on the first substrate, and is located in an orthographic projection area of the pad area on the first substrate.

Optionally, the display panel further includes a black shading layer between the second substrate and the second conductive layer, which is arranged corresponding to the second conductive layer.

An embodiment of the present application further provides a liquid crystal display device that includes a backlight module, a display panel, a sealant, a first metal layer, an organic film layer, a pad area, a first conductive layer, and a second conductive layer. The backlight module includes a lighting element, a reflective sheet, and a diffusion plate. The backlight module serves as a light source required by the display panel, and the display panel includes a display area, a peripheral area adjacent to the display area, a first substrate, a second substrate arranged opposite to the first substrate, and a display layer, wherein in a portion corresponding to the peripheral area, the display panel includes a sealant, a first metal layer, an organic film layer, a pad area, a first conductive layer, and a second conductive layer. The sealant includes a plurality of conductive particles. The first metal layer is arranged above the first substrate, and includes at least one first signal line. The organic film layer is arranged above the first metal layer, and includes a first flat portion, a second flat portion, and at least one via hole defined between the first flat portion and the second flat portion, wherein the via hole exposes the first signal line, and a vertical level of a top surface of the second flat portion is higher than a vertical level of a top surface of the first flat portion is located. The pad area is defined on the first signal line, wherein the via hole is located in the pad area. The first conductive layer is arranged above the first substrate, and includes a conductive pad, wherein the conductive pad covers the first signal line in the via hole, and is arranged towards the top surfaces of the first flat portion and the second flat portion of the via hole. The second conductive layer is arranged on one side of the second substrate adjacent to the sealant. Some of the conductive particles are located on the conductive pad of the second flat portion and contacting the second conductive layer, and the first signal line is electrically connected to the second conductive layer via the conductive pad and the conductive particles.

The present application has advantageous effects as follows: in the display panel and liquid crystal display device provided by the present application, by extending and widening the first signal line (i.e., the conduction location) of the conductive pad in the via hole, the contact range of the conductive particles between the second conductive layer and the conductive pad can be thus increased. In addition, the size of the conductive particles is calculated based on the premise that the bus line area film thickness and the display area film thickness are equal, so that the size of the conductive particles is adapted to better conforming to the bus line area, thereby reducing the gap between the bus line area and the conduction location. This solves the problem in the related art that the conductive particles of the sealant of the display panel cannot effectively contact the second conductive layer to conduct the upper substrate and the lower substrate, thereby reducing the difference height between the bus line area and the conducting location which can cause the brightness of the peripheral areas to be non-uniform when displaying images and affect the display quality.

### BRIEF DESCRIPTION OF DRAWINGS

To better illustrate embodiments or technical solutions in the prior art, a brief description of the drawings used in the embodiments or the prior art description will be given below. Obviously, the accompanying drawings in the following description merely show some embodiments of the present invention, and a person skilled in the art may still derive other drawings from these accompanying drawings without creative efforts.

FIG. 1 is a diagram illustrating a plane view of a display panel according to an embodiment of the present application.

FIG. 2 is a diagram illustrating a cross-sectional view of a peripheral area of the display panel shown in FIG. 1.

FIG. 3 is a diagram illustrating a pad area in the peripheral area of the display panel according to an embodiment of the present application.

FIG. 4 is a diagram illustrating a plane view of a conductive pad of the display panel located in the peripheral area according to an embodiment of the present application.

FIG. 5 is a diagram illustrating a plane view of a conductive pad of the display panel located in the peripheral area according to another embodiment of the present application.

FIG. 6 is a diagram illustrating the distribution of conductive particles of the display panel shown in FIG. 2.

FIG. 7 is a diagram illustrating a cross-sectional view of a liquid crystal display device according to an embodiment of the present application.

### DESCRIPTION OF PREFERRED EMBODIMENTS

The following descriptions of each embodiment refer to the attached figures to illustrate specific embodiments of the present application. The directional terms mentioned in the present application, such as up, down, front, back, left, right, inner, outer, side, etc. are merely used to indicate various directions in the attached figures. Therefore, the directional terms are merely for illustrative purposes, and are not meant to limit the scope of the present application. In the figures, units with similar structures may be indicated by the same reference numerals. For better understanding, the thickness of some layers and regions in the figures may be exaggerated. That is, size and thicknesses of each element in the figures are arbitrarily depicted, and the present application is not limited thereto.

The present application provides a display panel, and more particularly, a display panel including a sealant containing conductive particles, in order to improve the problem that conductive particles cannot effectively contact the color film substrate and the array substrate after the sealant is coated, and thereby reduce the unevenness image display of the peripheral area caused by the gap between film layers.

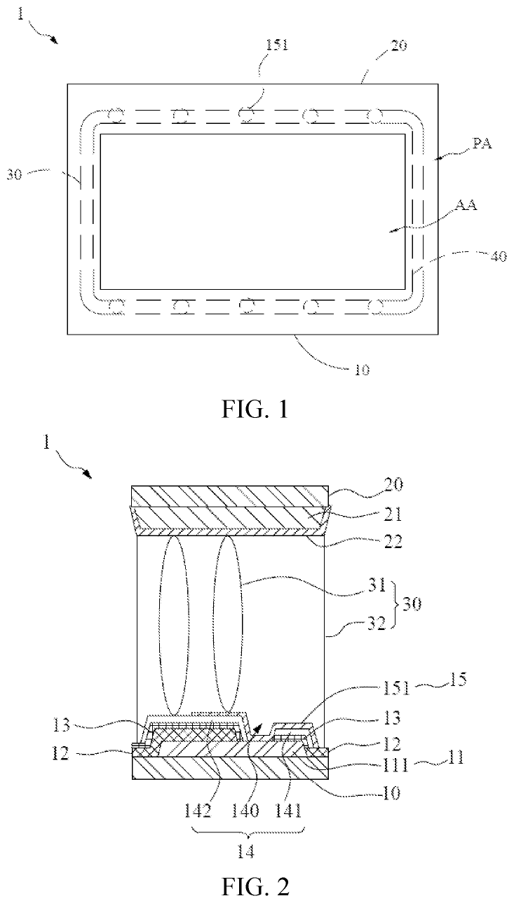

Please refer to FIG. 1 of the present application, which is a diagram illustrating a plane view of a display panel according to an embodiment of the present application. As shown in FIG. 1, the display panel 1 of the present application includes a display area AA (which denotes an active area), a peripheral area PA (which denotes a peripheral area) adjacent to the display area AA, a first substrate 10, a second substrate 20 arranged opposite to the first substrate 10, a sealant 30 arranged in the peripheral area PA, and a display layer 40 provided between the first substrate 10 and the second substrate 20. The first substrate 10 and the second substrate 20 may be glass substrates, quartz substrates, or plastic substrates, but the present invention is not limited thereto, however. The display layer 40 in this embodiment is a liquid crystal (LC) layer, and includes a plurality of LC molecules (not shown in the figure). Further, the display area AA of the display panel 1 is an area through which light can pass through to display an image. The peripheral area PA is mainly the area where the peripheral driving components and wiring are arranged. Because the peripheral area PA has black matrix patterns, the light is difficult to pass through. The peripheral area PA of the present embodiment is set around the periphery of the display area AA as an example.

It should be noted that the display panel of the present embodiment may be a liquid crystal display panel in an embodiment, while in another embodiment, the display panel may be an organic light-emitting diode display panel (not shown in the figure), and the display layer may be an organic light-emitting layer. In this way, the second substrate may be a protective cover plate to protect the organic light-emitting layer from external moisture or harmful objects.

Please refer to FIG. 2, which is a diagram illustrating a cross-sectional view of the peripheral area of the display panel shown in FIG. 1. As shown in FIG. 2, the sealant 30 of the present application is disposed in the peripheral area PA, and seals the periphery of the first substrate 10 and the second substrate 20, so that the display layer 40 is sealed between the first substrate 10 and the second substrate 20 (as shown in FIG. 1). It should be noted that the sealant 30 of the present application preferably adopts a conductive adhesive with conductive properties. As shown in FIG. 2, the sealant 30 is composed of conductive particles 31 and a colloid 32, wherein the conductive particles 31 are distributed in the colloid 32. Specifically, the conductive particles 31 can be made of gold, silver, copper, or aluminum, or made of spheres plated with gold, silver, copper, or aluminum. Alternatively, the conductive particles 31 may also include more than two spheres. The conductive particles 31 used in the present embodiment are gold balls, forming a sealant containing gold balls (e.g., Au in seal) configuration.

As shown in FIG. 2, the first substrate 10 of the present embodiment is provided with a first metal layer 11, a gate insulating layer 12, a passivation layer 13, an organic film layer 14, and a first conductive layer 15 sequentially disposed from bottom to top in the part corresponding to the peripheral area PA. It should be noted that the first substrate 10 of the present embodiment further includes thin film transistor devices arranged in an array (not shown in the figure) and a display layer 40 in a portion corresponding to the display area AA, wherein the structure of the thin film transistor device is a known art, and is thus omitted here for brevity. The working principle of the thin film transistor device is to turn on an active layer, a source, and a drain according to a scanning signal, and register the data according to the data signal to the FIG. element electrode, thereby controlling the rotation of the liquid crystal in the display layer 40 to display the image. In the present embodiment, the first substrate 10 is an array substrate (or lower substrate), and the second substrate 20 is a color film substrate (or upper substrate). The working principle of the thin film transistor device is to turn on the active layer, the source, and the drain according to the scanning signal, and transmit the data to the pixel electrode according to the data signal, thereby controlling the rotation of the liquid crystal in the display layer 40 to display the image. In the present embodiment, the first substrate 10 is an array substrate (also referred to as a lower substrate), and the second substrate 20 is a color film substrate (also referred to as an upper substrate).

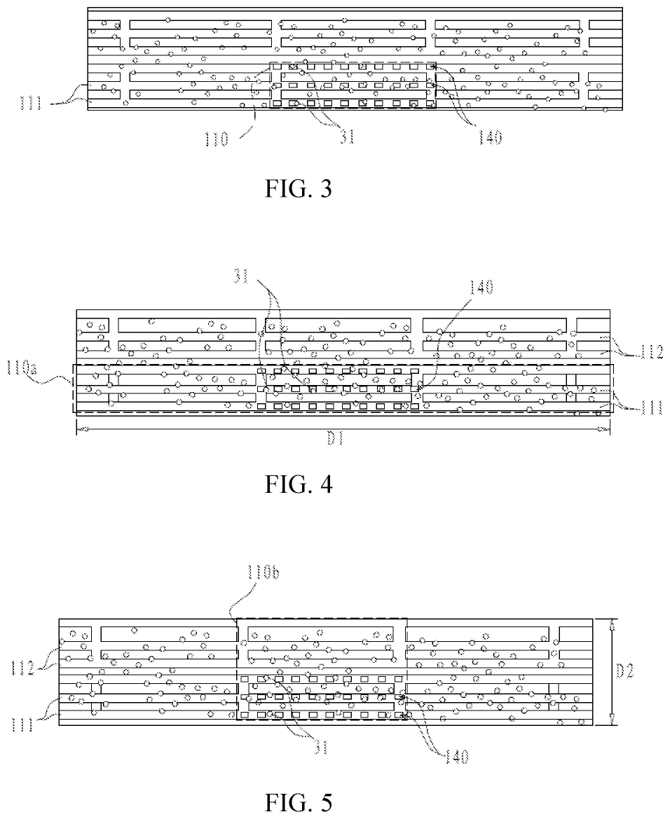

It should be noted that the first metal layer 11 of the present embodiment includes a plurality of first signal lines 111 and a plurality of second signal lines 112 (as shown in FIG. 3), wherein the first signal line 111 and the second signal line 112 are respectively arranged to transmit a common electrode signal. Further, identical to general thin film transistor display panels, a second metal layer (not shown in the figure) is further provided on the first substrate 10 of the present application, which includes a data signal line. However, due to the view angle of FIG. 2, the view of the second metal layer in FIG. 2 is blocked by the organic film layer 14, the passivation layer 13, and the gate insulating layer 12, and is therefore not shown. It should be noted that the present embodiment may be implemented by directly forming a gate driver circuit on the gate driver on array (GOA) of the array area on the first substrate 10, which can effectively reduce weight of the display panel, thereby simplifying the production process procedures. Due to the use of the GOA circuit, the driver IC and other components required for the display panel 1 of the present embodiment are mainly arranged in the peripheral area PA on the upper or lower side of the display panel 1, thereby achieving the effect of narrowing the display panel.

Please go on referring to FIG. 2. The second substrate 20 of the present application is sequentially provided with a black shading layer 21 and a second conductive layer 22 in the direction of the first substrate 10 in the part corresponding to the peripheral area PA, wherein the black shading layer 21 serves as a black matrix layer for shading, and the second conductive layer 22 is adjacent to the sealant 30. Further, in the portion of the second substrate 20 corresponding to the display area AA, a color filter layer (not shown in the figure) is provided between the second conductive layer 22 and the second substrate 20. The first conductive layer 15 and the second conductive layer 22 of the present embodiment may be made of indium tin oxide (ITO), indium zinc oxide (IZO), aluminum zinc oxide (AZO), cadmium tin oxide (CTO), tin oxide (SnO2), or zinc oxide (ZnO). The above are merely for illustrative purposes, and the present invention is not limited thereto. As shown in FIG. 2, the sealant 30 is provided between the first conductive layer 15 and the second conductive layer 22, and contacts the first conductive layer 15 and the second conductive layer 22 by attaching.

Please refer to FIG. 3 along with FIG. 2. FIG. 3 is a diagram illustrating a pad area of the peripheral area of the display panel according to an embodiment of the present application. As shown in FIG. 3, the first signal line 111 and second signal line 112 of the first metal layer 11 of the present embodiment are respectively arranged to transmit the common electrode signal. Specifically, the first signal line 111 is arranged to transmit the common electrode signal of the second substrate 20, and the second signal line 112 is arranged to transmit the common electrode signal of the first substrate 10. A plurality of first signal lines 111 and a plurality of second signal lines 112 are arranged in a spaced manner, and the second signal lines 112 are arranged on one side of the first signal line 111. It should be noted that the present embodiment may be further coated with an organic film layer 14 (as shown in FIG. 2) on the passivation layer 13, i.e., a polymer film on array (PFA). The arrangement of the organic film layer 14 can further change the flatness of the film layer underneath, achieve flattening, and prevent mutual interference of electric fields. In another embodiment, especially in large-size display products, the PFA film can also be used alone to replace the passivation layer.

Further, as shown in FIG. 3, the present embodiment has a pad area 110 defined on a plurality of first signal line 111, wherein a plurality of via holes 140 are spaced apart from each other and arranged in an array, and is located in the pad area 110. That is, the pad area 110 is a range that defines the arrangement of the plurality of via holes 140. Specifically, the orthographic projection area of a plurality of via holes 140 on the first substrate 10 is located in the orthographic projection area of conductive pad 151 (which is described later) of the first conductive layer 15 on the first substrate 10, and is located in the orthographic projection area of the pad area 110 on first substrate 10.

As shown in FIG. 2, the organic film layer 14 of the present application is provided on the first metal layer 11, and includes a first flat portion 141, a second flat portion 142 adjacent to the first flat portion 141, and a via hole 140 between to the first flat portion 141 and the second flat portion 142. The via hole 140 is arranged to expose the first signal line 111 of the first metal layer 11. In the actual process, the organic film layer 14 is first coated on the passivation layer 13, and then a plurality of via holes 140 are formed by a photolithography process including exposure, development and etching, and finally the first signal line 111 is exposed. Please go on referring to FIG. 2, a gate insulating layer 12 and a passivation layer 13 are sequentially provided between the first signal line 111 and the second flat portion 142 of the organic film layer 14. That is, an area from the second flat portion 142 to the first substrate 10 is defined as a bus line area. Further, only the passivation layer 13 is provided between the first signal line 111 and the first flat portion 141 of the organic film layer 14. Specifically, the gate insulating layer 12 below the second flat portion 142 is stacked on some of the first signal line 111, and the passivation layer 13 below the first flat portion 141 is stacked on some of the first signal line 111, wherein a via hole 140 is provided between the first flat portion 141 and the second flat portion 142.

Please go on referring to FIG. 2, the conductive particles 31 between the first conductive layer 15 on the first substrate 10 and the second conductive layer 22 of the second substrate 20 are dispersed in the colloid 32. Specifically, the conductive particles 31 are scattered on the first flat portion 141 and the second flat portion 142. However, since the display panel 1 has more film layers in the corresponding part of the bus line area, a vertical level of the top surface of the second flat portion 142 is higher than a vertical level of the top surface of the first flat portion 141, resulting in a gap between the first flat portion 141 and the second flat portion 142 on the cross section. Further, the topography of the via hole 140 is lower than the first flat portion 141 and the second flat portion 142, so that some conductive particles 31 may fall on a low level via holes 140 and thus cannot contact the second conductive layer 22. In other words, the gap causes the conductive particles 31 cannot contact the upper substrate, and thus cannot conduct the second conductive layer 22 (i.e., the color film substrate or upper substrate) and the first conductive layer 15 (i.e., the array substrate or the lower substrate), resulting in the problem of uneven display brightness (mura) of the peripheral area.

To solve the above problems, in some embodiments of the present application, the first conductive layer 15 on the first substrate 10 includes the conductive pad 151. The conductive pad 151 covers the first signal line 111 in the via hole 140 and extends towards the top surfaces of the first flat portion 141 and the second flat portion 142 of the adjacent via hole 140. That is, the conductive pad 151 not only completely covers and contacts the first signal line 111 in the corresponding via hole 140, but is also arranged along the sidewalls of the first flat portion 141 and the second flat portion 142 of the adjacent via hole 140 to the top surface. As shown in FIG. 2, a larger area where the conductive pad 151 is arranged is added to the second flat portion 142 to accommodate the conductive particles 31. In particular, as shown in FIG. 2 of the present application, the area of the orthographic projection area of the second flat portion 142 of the organic film layer 14 on the first substrate 10 is larger than the area of the orthographic projection area of the first flat portion 141 on the first substrate 10, thus further extending a distribution area of the range of conductive pad 151. Accordingly, by extending and widening design of the first signal line 111 (i.e., conduction location) of the conductive pad 151 in the via hole 140, the contact area of the of the conductive particles 31 between the second conductive layer 22 and the conductive pad 151 is increased, thereby effectively reducing the impact of the gap between the second flat portion 142 and the first flat portion 141 or the gap between the second flat portion 142 and the via hole 140, and improving the mura effect in peripheral areas caused by the Au in seal design.

Please refer to FIG. 4, which is a diagram illustrating a plane view of a conductive pad 151 of the display panel 1 located in the peripheral area PA according to an embodiment of the present application. Specifically, in the present embodiment, the conductive pad 151 of the first conductive layer 15 covers the pad area 110, and extends out the pad area 110 in the first direction D1 or the second direction D2. That is, the area of the orthographic projection area of the conductive pad 151 on the first substrate 10 is larger than the area of the orthographic projection area of the pad area 110 on the first substrate 10. As shown in FIG. 4, the conductive pad 151 extends out in the first direction D1 from the left and right of the pad area 110, thus forming a widen first conductive pad range 110a, which is larger than the range of the pad area 110. The first direction D1 is a direction of coating the sealant 30 along the peripheral area PA, and is located on a plurality of first signal lines 111. As shown in FIG. 4, the area of each via hole 140 in the pad area 110 is smaller than the area of the pad area 110 and the area of the first conductive pad range 110a.

Please refer to FIG. 5 along with FIG. 3. FIG. 5 is a diagram illustrating a plane view of a conductive pad 151 of the display panel 1 located in the peripheral area PA according to another embodiment of the present application. As shown in FIG. 5, the conductive pad 151 extends out the pad area 110 along the pad area 110 in the second direction D2, thus forming a widen second conductive pad range 110b, which is larger than the range of the pad area 110. That is, the conductive pad 151 extends in the second direction D2 to the area above the second signal line 112, and is perpendicular to the first direction D1. In other words, the second direction D2 is perpendicular to a direction of coating the sealant 30 along the peripheral area PA. By extending the conductive pad 151 toward the first direction D1 and/or the second direction D2, the conduction area of the second substrate 20 (i.e., the upper substrate) and first substrate 10 (i.e., the lower substrate) is greatly increased, making conductive particles 31 positioned on the conductive pad 151 on the second flat portion 142. Further, the first signal line 111 is electrically connected to the second conductive layer 22 through the conductive pad 151 and the conductive particles 31, thereby improving the problem of uneven brightness in the peripheral areas of the display panel.

It should be noted that in order to reduce the situation where the conductive particles 31 cannot contact the second conductive layer 22 in the via hole 140, the present embodiment forms a plurality of via holes 140 only in the portion of the organic film layer 14 corresponding to the first signal line 111 (as shown in FIG. 4 and FIG. 5). After the display panel 1 of the present application is optimized, the area of the via holes 140 is relatively small compared with the area of the bus line area, thus further reducing the gap between the second flat portion 142 (i.e., the bus line area) and the first flat portion 141. As a result, the mura effect around the peripheral areas of the display panel can be improved.

Further, the calculation of conductive particles in the peripheral area of the related art display panels does not take into account the difference in topography of where the conductive pad is being conducted and the bus line area, thus causing the conductive particles in the bus line area to prop up the display panel due to the large size, and causing poor conduction of the first metal layer and the first conductive layer of the upper substrate at the conductive pad. On the other hand, the above issues also cause the gap between the bus line area and the display area AA become too large. The above problems are solved by the present application by improving the way of calculating the size of the conductive particles 31, which is described later.

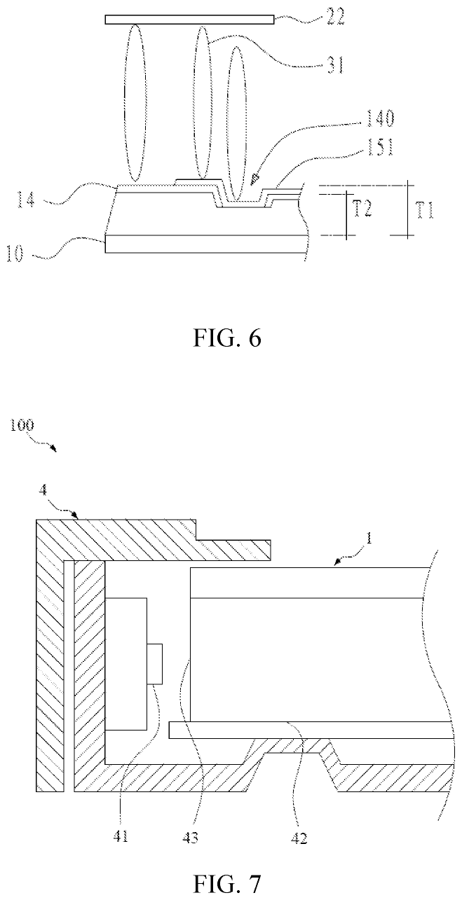

Please refer to FIG. 6, which is a diagram illustrating the distribution of the conductive particles 31 of the display panel 1 shown in FIG. 2. In an embodiment of the present application, the total thickness of the entire film layer from the upper surface of the first substrate 10 to the top surface of the second flat portion 142 of the organic film layer 14 is defined as the bus line area film thickness T1, and the total thickness of the entire film layer above the upper surface of the first substrate 10 in the display area AA is defined as the display area film thickness T2. It should be noted however, in the present embodiment the conditions of calculating the size of the conductive particles 31 are based at least on a premise that the bus line area film thickness T1 and the display area film thickness T2 are equal. Under the calculation based on the above premise, the size of the conductive particles 31 can be adapted to the arrangement of the bus line area, so that the second substrate 20 (i.e., the upper substrate) will not be propped up by squeezing. As a result, the gap between different film layers can be prevented, and the conductive particles 31 can be conducted to the second substrate 20 (i.e., the upper substrate) on the widen area of the conductive pad 151, thereby improving the mura effect around the peripheral areas of the display panel can be improved.

Please refer to FIG. 7, which is a diagram illustrating a cross-sectional view of a LC display device 100 according to an embodiment of the present application. As shown in FIG. 7, the LC display device 100 includes a backlight module 4 and the display panel 1 in the above embodiments. The backlight module 4 is illustrated as “edge-lit” in the in present embodiment, and is arranged to provide the light source required by the display panel 1. The backlight module 4 includes optical elements such as a lighting element 41, a reflective sheet 42 and a diffusion plate, etc. The detailed structure of the backlight module 4 is identical to that of related art LC display device, and the detailed descriptions are omitted here for brevity.

In view of the above, in the display panel and LC display device provided by the present application, by extending and widening the first signal line (i.e., the conduction location) of the conductive pad in the via hole, the contact range of the conductive particles between the second conductive layer and the conductive pad can be thus increased. In addition, the size of the conductive particles is calculated based on the premise that the bus line area film thickness and the display area film thickness are equal, so that the size of the conductive particles is adapted to better conforming to the bus line area, thereby reducing the gap between the bus line area and the conduction location. This solves the problem in the related art that the conductive particles of the sealant of the display panel cannot effectively contact the second conductive layer to conduct the upper substrate and the lower substrate, thereby reducing the difference height between the bus line area and the conducting location which can cause the brightness of the peripheral areas to be non-uniform when displaying images and affect the display quality.

Descriptions corresponding the above-mentioned embodiments are provided as the above. However, if part of descriptions is not found in a particular embodiment, they can be realized by referring to other embodiments.

Accordingly, although the present invention has been disclosed as a preferred embodiment, it is not intended to limit the present invention. Those skilled in the art without departing from the scope of the present invention may make various changes or modifications, and thus the scope of the present invention should be after the appended claims and their equivalents.

What is claimed is:

1. A display panel comprising a display area, a peripheral area adjacent to the display area, a first substrate and a second substrate arranged opposite to the first substrate, and a display layer, wherein in a portion corresponding to the peripheral area, the display panel comprises:
a sealant comprising a plurality of conductive particles;
a first metal layer arranged above the first substrate and comprising at least one first signal line;
an organic film layer arranged on the first metal layer and comprising a first flat portion, a second flat portion, and at least one via hole defined between the first flat portion and the second flat portion, wherein the via hole exposes the first signal line, and a vertical level of a top surface of the second flat portion is higher than a vertical level of a top surface of the first flat portion is located;
a pad area defined on the first signal line, wherein the via hole is located in the pad area;
a first conductive layer arranged on the first substrate and comprising a conductive pad, wherein the conductive pad covers the first signal line in the via hole and is arranged extending to the top surfaces of the first flat portion and the second flat portion adjoining the via hole; and
a second conductive layer arranged on one side of the second substrate adjacent to the sealant;
wherein some of the conductive particles are located on the conductive pad of the second flat portion and contacting the second conductive layer, and the first signal line is electrically connected to the second conductive layer via the conductive pad and the conductive particles.

2. The display panel of claim 1, further comprising a gate insulating layer and a passivation layer sequentially provided between the first signal line and the second flat portion of the organic film layer, wherein the passivation layer is located between the first signal line and the first flat portion of the organic film layer, the gate insulating layer under the second flat portion is stacked on some of the first signal line, and the passivation layer under the first flat portion is stacked on some of the first signal line.

3. The display panel of claim 1, wherein a total thickness of entire film layers between an upper surface of the first substrate and the top surface of the second flat portion of the organic film layer is defined as a bus line area film thickness, and a total thickness of entire film layers above the upper surface of the first substrate in the display area is defined as a display area film thickness, wherein calculation of a size of the conductive particles is based at least on a premise that the bus line area film thickness and the display area film thickness are equal.

4. The display panel of claim 1, wherein the conductive pad extends out of the pad area in a first direction or in a second direction, and an orthographic projection area of the conductive pad on the first substrate is larger than an orthographic projection area of the pad area on the first substrate.

5. The display panel of claim 4, wherein the first metal layer further comprises at least one second signal line, the second signal line is spaced apart from the first signal line, and the conductive pad extends in the second direction to the second signal line.

6. The display panel of claim 4, wherein the first direction is a direction along which the sealant is coated on the peripheral area, and the second direction is perpendicular to the first direction.

7. The display panel of claim 1, wherein an orthographic projection area of the second flat portion of the organic film layer on the first substrate is larger than an orthographic projection area of the first flat portion of the organic film layer on the first substrate.

8. The display panel of claim 1, wherein the organic film layer comprises the plurality of via holes, the plurality of via holes are spaced apart from each other, and an orthographic projection area of the plurality of via holes on the first substrate is located in an orthographic projection area of the conductive pad on the first substrate, and is located in an orthographic projection area of the pad area on the first substrate.

9. The display panel of claim 1, further comprising a black shading layer between the second substrate and the second conductive layer, which is arranged corresponding to the second conductive layer.

10. A liquid crystal display device comprising:
a backlight module comprising a lighting element, a reflective sheet, and a diffusion plate; and
a display panel, wherein the backlight module serves as a light source required by the display panel, and the display panel comprises a display area, a peripheral area adjacent to the display area, a first substrate, a second substrate arranged opposite to the first substrate, and a display layer, wherein in a portion corresponding to the peripheral area, the display panel comprises:
a sealant comprising a plurality of conductive particles;
a first metal layer, arranged above the first substrate and comprising at least one first signal line;
an organic film layer arranged above the first metal layer and comprising a first flat portion, a second flat portion, and at least one via hole defined between the first flat portion and the second flat portion, wherein the via hole exposes the first signal line, and a vertical level of a top surface of the second flat portion is higher than a vertical level of a top surface of the first flat portion is located;
a pad area defined on the first signal line, wherein the via hole is located in the pad area;
a first conductive layer arranged above the first substrate and comprising a conductive pad, wherein the conductive pad covers the first signal line in the via hole, and is arranged towards the top surfaces of the first flat portion and the second flat portion of the via hole; and
a second conductive layer arranged on one side of the second substrate adjacent to the sealant;
wherein some of the conductive particles are located on the conductive pad of the second flat portion and contacting the second conductive layer, and the first signal line is electrically connected to the second conductive layer via the conductive pad and the conductive particles.

11. The liquid crystal display device of claim 10, further comprising a gate insulating layer and a passivation layer sequentially provided between the first signal line and a second flat portion of the organic film layer, wherein the passivation layer is located between the first signal line and the first flat portion of the organic film layer, the gate insulating layer under the second flat portion is stacked on some of the first signal line, and the passivation layer under the first flat portion is stacked on some of the first signal line.

12. The liquid crystal display device of claim 10, wherein a total thickness of entire film layers between an upper surface of the first substrate and the top surface of the second flat portion of the organic film layer is defined as a bus line area film thickness, and a total thickness of entire film layers above the upper surface of the first substrate in the display area is defined as a display area film thickness, wherein calculation of a size of the conductive particles is based at least on a premise that the bus line area film thickness and the display area film thickness are equal.

13. The liquid crystal display device of claim 10, wherein the conductive pad extends out of the pad area in a first direction or in a second direction, and an orthographic projection area of the conductive pad on the first substrate is larger than an orthographic projection area of the pad area on the first substrate.

14. The liquid crystal display device of claim 13, wherein the first metal layer further comprises at least one second signal line, the second signal line is spaced apart from the first signal line, and the conductive pad extends in the second direction to the second signal line.

15. The liquid crystal display device of claim 13, wherein the first direction is a direction along which the sealant is coated on the peripheral area, and the second direction is perpendicular to the first direction.

16. The liquid crystal display device of claim 10, wherein the organic film layer comprising the plurality of via holes, the plurality of via holes are spaced apart from each other, and an orthographic projection area of the plurality of via holes on the first substrate is located in an orthographic projection area of the conductive pad on the first substrate, and is located in an orthographic projection area of the pad area on the first substrate.

17. The liquid crystal display device of claim 10, further comprising a black shading layer between the second substrate and the second conductive layer, which is arranged corresponding to the second conductive layer.
